(19) United States
(12) Patent Application Publication
(10) Pub. No.: US 2005/0233149 A1
(43) Pub. Date: Oct. 20, 2005

(54) Curable compositions

(76) Inventor: Christopher Ansell, Easingwold (GB)

Correspondence Address: STITES & HARBISON PLLC, 1199 NORTH FAIRFAX STREET, SUITE 900, ALEXANDRIA, VA, 22314, US

(21) Appl. No.: 11/151,520

(22) Filed: Jun. 14, 2005

Related U.S. Application Data
(63) Continuation of application No. 10/767,991, filed on Feb. 2, 2004, now abandoned.
Application No. 10/767,991 is a continuation of application No. 09/958,334, filed on Dec. 7, 2001, now abandoned.

(30) Foreign Application Priority Data
Apr. 9, 1999 (GB) 9908000.4

(51) Int. Cl. B32B 9/00

(52) U.S. Cl. 428/420

(57) ABSTRACT

A radiation switchable polymer, especially a visible or UV light switchable adhesive polymer capable of switching from a tacky to a less tacky state, a composition thereof, a process for the manufacture of the composition, and a dressing comprising the polymer. The polymer has a backbone polymeric moiety having radiation curable residues on it, and the polymer may be synthesised in a single step by choice of groups in the monomers such that polymerisation leaves the curable residues on it unreacted. For example, the polymer may be synthesised from norborn-2-ene with methacrylate groups on the monomer, such that polymerisation via a ring opening metathesis polymerisation may be carried out without affecting the methacrylate groups.

The present invention relates to curable compositions, and to processes for producing curable compositions. It also relates to polymers for use in such compositions, and to processes for producing such polymers. It further relates to articles comprising curable compositions and to methods of using such articles.

In particular this invention relates to ‘switchable’ adhesive compositions. That is, adhesive compositions capable of being influenced to change from a tacky to a less tacky, or even non-tacky, state thereby reducing the peel strength of the adhesive composition.

In particular this invention also relates to ‘switchable’ hardenable compositions. That is, hardenable compositions capable of being influenced to change from a fluid or flexible to a solid or less flexible, or even rigid, state thereby increasing the strength of the hardenable composition.

Adhesive products such as adhesive surgical or medical dressings and bandages normally comprise a layer of a pressure sensitive adhesive. However, when conventional adhesive dressings and/or bandages are removed, they often cause localised trauma to the patient.

There has therefore long been a desire to provide adhesive dressings that can exhibit a reduction in peel strength of the adhesive, for example by being capable of being changed from a tacky to a less tacky, or even non-tacky, state.

Such ‘switchable adhesives’ would cause less localised trauma than conventional adhesives when the dressing is removed.

Switchable adhesives are known. For example, U.S. Pat. Nos. 5,032,637, 5,352,516, 4,331,576 and 5,182,323 describe adhesives that become less tacky, that is, are switchable, in contact with water. However, such adhesives are unsuitable, for example, if used on a wound dressing and the patient's wound needs to be kept dry.

UV switchable adhesives are described in U.S. Pat. Nos. 4,286,047, 4,968,559 and 5,118,567 and Japanese Patent No. 3043988. Such adhesives suffer from the disadvantage that they may require high doses of UV radiation or may need to be used in conjunction with photoinitiators, which result in undesirable by-products.

It remains undesirable to expose patients to too much ultra violet radiation.

There therefore remains a need for a switchable adhesive that can undergo a reduction in peel strength at low dosages of UV radiation or more preferably by exposure to visible light irradiation.

In our International Patent Publication No WO 97/06836 we describe a switchable adhesive formulation. This comprised inter alia a modified acrylic adhesive based on copolymers of alkyl acrylates, acrylic acid and/or a free radical adhesive vinyl moiety, functionalised by an adhesive moiety bonded thereto. Such adhesive moieties include those derived from anthracenes, cinnamates, maleimides, coumarins, acrylates and/or methacrylates.

One problem associated with the use of such moieties is the difficulty in synthesis and their relatively aggressive adhesive characteristics.

The polymerisation of prior art methacrylate functionalised switchable adhesives requires the use of multiple stage preparative processes in order
a) firstly to produce a polymer having a sufficiently high molecular weight for it to be used as a medical adhesive and
b) secondly to carry out the reaction of the functionalising moiety with the main polymer chain.

Hardenable products such as hardenable orthopaedic prostheses and bandages normally comprise a body or layer respectively of a material that is sensitive to, and hardenable in response to, conventional materials or radiation.

When such bandages are applied, however, they often inconvenience the patient or the applier.

There has therefore long been a desire to provide hardenable prostheses and bandages where a change in strength of a hardenable component can be readily brought about, by change from a fluid or flexible to a solid or less flexible or even rigid, state.

Such ‘switchable hardenable’ bandages would cause less inconvenience than conventional hardenable bandages on application.

Switchable hardenable bandages are known, for example hardenable bandages that become less flexible, that is, are switchable, in contact with water. However, such hardenable bandages are unsuitable, for example, if used as an orthopaedic splint bandage and the patient's fracture needs to be kept dry.

UV switchable hardenable bandages are known. However, such hardenable bandages suffer from the disadvantage that they may require high doses of UV radiation or may need to be used in conjunction with photoinitiators, which result in undesirable by-products. It remains undesirable to expose patients to too much ultra violet radiation.

There therefore remains a need for a switchable hardenable bandage that can undergo an increase in strength at low dosages of UV radiation or more preferably by exposure to visible light irradiation.

One problem associated with the use of such materials is the difficulty in synthesis and their relatively aggressive biological characteristics.

The polymerisation of prior art switchable hardenable materials requires the use of multiple stage preparative processes in order
a) firstly to produce a polymer having a sufficiently high molecular weight for it to be used as an orthopaedic hardenable material, and
b) secondly to carry out the reaction of the functionalising moiety with the main polymer chain.

We have now surprisingly found a curable material that is switchable when exposed to radiation, in particular to electromagnetic, especially actinic radiation, that is, visible or UV light.

Such a switchable curable has better curable properties than known switchable curable materials and does not require a multiple stage preparative process.

Thus according to one aspect of the present invention we provide a switchable curable composition capable of being cured by radiation that includes a switchable polymer comprising a backbone polymeric moiety having a plurality of curable moieties bonded thereto. It is characterised in that the polymer comprises monomer residues each of which monomers comprises at least two reactive groups, at least one of which is curable but unreactive under conditions under which at least one of the remaining groups undergoes reaction to form the polymer.

When used herein, the term ‘curable’ means reactable by way of addition or condensation, to link or cross-link the switchable polymer to increase the molecular weight of the polymer to which the moieties are bound.

Where the polymer is adhesive or a component of an adhesive composition, this renders the adhesive or composition changeable from a tacky to a less tacky, or even non-tacky, state (that is, renders it switchable). It does so by producing a polymer of increased molecular weight.

Where the polymer is a hardenable material or a component of a composition that is hardenable, this renders the material or composition changeable from a fluid or flexible to a solid or less flexible, or even rigid, state (that is, renders it switchable). It does so by producing a polymer of increased molecular weight by way of linking or cross-linking the switchable polymer.

When used herein, the term ‘curable but unreactive under conditions under which at least one of the remaining groups undergoes reaction to form the polymer’ includes a reference to reactive groups that
a) are capable of curing as hereinbefore defined, but
b) are not significantly reactive under the reaction conditions for each of the remaining groups that are forming the polymer.

Groups that react in this manner by a different mechanism from each of the remaining groups, and hence are unreactive during polymerisation, are particularly advantageous, since they may facilitate more selective reactions.

Alternatively, but less desirably, all the groups react by essentially the same mechanism, but the remaining groups are significantly more reactive than the curable but unreactive groups.

The or each group that is curable but unreactive under conditions under which at least one of the remaining groups undergoes reaction to form the polymer is preferably a free-radically reactive group.

It is preferably curable but unreactive under conditions under which each of the remaining groups undergoes addition or condensation to cause polymerisation.

When used herein, the term ‘free-radically reactive groups’ means any groups that can undergo addition to other groups by free radical transfer.

Thus according to one embodiment of the first aspect of the present invention we provide a switchable adhesive composition capable of being influenced by radiation to change from a tacky to a less tacky state that includes a switchable polymer as hereinbefore defined in relation to the first aspect of the invention.

Thus according to another embodiment of the first aspect of the present invention we provide a switchable hardenable composition capable of being influenced by radiation to change from a fluid or flexible to a solid or less flexible state that includes a switchable polymer as hereinbefore defined in relation to the first aspect of the invention.

One further embodiment of this aspect of the present invention is characterised in that the polymer comprises monomer residues each of which monomers comprises at least two reactive groups, as follows: At least one of said groups is free-radically reactive (‘curable’) but unreactive under conditions under which at least one of the remaining groups undergoes reaction to form the polymer.

The switchable polymer may form the sole curable constituent of the curable composition, or it may be blended with other curable materials, for example in a hardenable composition of the present invention.

The switchable polymer may have adhesive properties, in which case it may form the sole adhesive constituent of an adhesive composition, or it may be blended with other adhesives.

In such a switchable adhesive composition of the invention, the switchable polymer need not itself have adhesive properties, in which case it is blended with one or more adhesives.

Thus in another embodiment of this aspect of the present invention we provide a switchable adhesive composition of the present invention.

It is characterised in that it comprises a switchable polymer as hereinbefore described which is adhesive, or a switchable polymer as hereinbefore described which is non-adhesive in admixture with a non-switchable adhesive.

For the sake of brevity, all the characteristic polymers of the present compositions will herein be referred as “switchable polymer(s)”.

In a second aspect therefore the present invention provides a switchable polymer capable of being influenced by radiation to change from one state to another, comprising a backbone polymeric moiety having a plurality of curable residues bonded thereto. It is characterised in that the polymer comprises monomer residues each of which monomers comprises at least two reactive groups, at least one of which is reactive (‘curable’) but unreactive under conditions under which at least one of the remaining groups undergoes reaction to form the polymer.

The monomer residues are preferably photocurable monomer residues. By this term we mean moieties that are capable of undergoing a reaction induced by electromagnetic, in particular by actinic, radiation.

Often such moieties will require the presence of at least one free radical initiator to initiate the reaction under the influence of incident radiation. Such initiators are described further below.

Examples of such reactions include, for example, photocuring to increase the molecular weight of the polymer to which the moieties are bound.

The monomer residues form a backbone polymeric moiety with pendent curable moieties in a single step by addition or condensation of the reactive groups in the monomers to cause polymerisation.

This avoids the need in the prior art for forming a polymer comprising the backbone polymeric moiety and then chemically bonding a precursor of the monomer residue to the backbone polymeric moiety.

The switchable adhesive composition of the present invention preferably has a peel strength in its non-tacky state that is at most 50% of that in its tacky state, preferably at most 25 or 20%, in particular 10%.

The switchable hardenable composition of the present invention preferably has a flexural strength in its solid or less flexible state that is at least 200% of that in its fluid or flexible state, preferably at least 400 or 500%, in particular 1000%.

Any monomers may be used to form the polymeric moiety provided that such monomers are reactable to form a backbone polymeric moiety but leave curable but unreacted moieties thereon. This may occur, for example, by forming polyadducts or polycondensates of the monomer precursors of the residues.

Preferred switchable polymers include polyurethanes and poly(alkenylene(poly)cycloalkyl)s, with free radical curable acryloyl or methacryloyl moieties.

Poly(alkenylene(poly)cycloalkyl)s are especially preferred as the materials forming the backbone polymeric moiety.

By the term ‘poly(alkenylene(poly)cycloalkyl)’ we include polymers based on monomers that are suitably-functionalised derivatives of polycycloalkenes, including comonomers of the same with optionally substituted polycycloalkenes.

It may be a copolymer of one or more polycycloalkenes, at least one of which comprises acrylate based curable moieties.

Such alkenylene(poly)cycloalkyl switchable polymers may be formed from corresponding polycycloalkene monomers by a ring opening metathesis polymerisation reaction.

For example an alkenylene(poly)cycloalkyl polymer that is an ethenylenecyclopentyl polymer and contains curable acryloxy or methacryloxy groups and optionally other substituents that are inert, such as alkoxycarbonyl (ester) groups, may be formed by such an opening metathesis polymerisation reaction between
a) , norbornenyl acrylate or methacrylate, and
b) optionally inertly substituted norbornene.

The acryloxy or methacryloxy groups stay curable and unreacted under the conditions under which each of the bicycloalkene groups undergoes the polymerisation reaction.

Any polycycloalkene species is suitable as the monomer precursor of the backbone polymer residues provided that it
a) is capable of a ring opening metathesis polymerisation reaction, and
b) comprises at least one group, for example one or two groups, each or which is curable but unreactive under conditions under which the polycycloalkene group undergoes such a reaction.

Suitable polycycloalkene monomer species include those capable of undergoing ring opening metathesis polymerisation, wherein the backbone cyclic moiety includes 2-4 rings, each of which independently has 3 to 8 carbon atoms, optionally substituted by one or more oxa groups.

Preferably the monomer has 2 or 3 rings, each of which has 4 to 7 carbon atoms and is unsubstituted. The species may be for example a norbornene derivative.

Suitable monomer precursors of the residues include those which comprise any groups that are
a) curable but
b) unreactive under conditions under which each of the polycycloalkene groups undergoes a ring opening metathesis polymerisation reaction.

Suitable such groups include at least one, often just one, free-radically active group that does not react as the other functional groups react to form the backbone polymeric moiety.

Such groups include acryloyl or methacryloyl.

Preferred monomers of this type include
alkenoate mono- and di-esters, in particular mono- and bis-C₃₋₆ alkenoyloxy-C₆₋₁₀ bi- to tetra-cycloalkenes, such as 5-acryloxy-, 5-methacryloxy-, 5,6-diacryloxy- and 5,6-di(methacryloxy)-norbornene;
polycycloalkenyl-2′-C₁₋₆ alk-1′-en-1′-yl-C₁₋₆ alkanoates, such as norbornen-5-yl-2′-acryloyl or methacryloyl acetate; and
polycycloalkenyl- mono- and bis-C₁₋₆ alkanoic C₁₋₆ alkyl esters substituted in the alkyl group with free-radically active alkene functions, such as 5-(2′-acryloxyethoxycarbonyl)-, 5-(2′-methacryl-oxyethoxycarbonyl)-, 5,6-bis(2′-acryloxyethoxycarbonyl)-, and 5,6-bis(2′-methacryloxyethoxy-carbonyl)-norbornene; and mixtures thereof;
   in which the 5- and 6-substituents may each independently be in the exo- or endo- orientation.

Especially preferred are
5-acryloxy-, 5-methacryloxy-, 5,6-diacryloxy- and 5,6-di(methacryl-oxy)-norbornene; and

5-(2′-acryloxyethoxycarbonyl)-, 5-(2′-methacryloxyethoxycarbonyl)-, 5,6-bis(2′-acryloxyethoxycarbonyl)-, and 5,6-bis(2′-methacryloxy-ethoxycarbonyl)-norbomene; and mixtures thereof;

in which the 5- and 6-substituents may each independently be in the exo- or endo- orientation.

Preferred polymers include homopolymers and copolymers of any of
5-acryloxy-, 5-methacryloxy-, 5,6-diacryloxy- and 5,6-di(meth-acryloxy)-norbornene; and
5-(2′-acryloxyethoxycarbonyl)-, 5-(2′-methacryloxyethoxycarbonyl)-, 5,6-bis(2′-acryloxyethoxycarbonyl)-, and 5,6-bis(2′-methacryloxy-ethoxycarbonyl)-norbornene;
   in which the 5- and 6-substituents may each independently be in the exo- or endo- orientation.

The amount of this monomer residue present in the switchable curable composition may vary.

This will depend, inter alia, upon the amount of tackiness desired in the switchable polymer when it switches from its tacky to its less or non-tacky state.

Thus, the amount of the monomer residue present in the switchable curable composition may be from 0.4 to 50% by weight of the polymer, preferably from 0.4 to 40% by weight and more preferably from 0.4 to 20% by weight.

The polymer may be a copolymer of the monomer or monomers with the curable moieties with one or more polycycloalkene species that also comprise at least one, for example one or two, other groups.

Such groups are often inert, and include groups such as
carboxyl groups and derivatives thereof, for example esters, in particular C₆₋₁₂ alkyl esters, such as 2-ethylhex-1-yloxycarbonyl, and amide groups;
hydroxyl groups and derivatives thereof, for example ester derivatives; and
   derivatives of two such groups on adjacent ring carbon atoms, for example lactones.

Preferred groups include C₆₋₁₂ alkyl ester groups, in particular 2-ethylhex-1-yloxycarbonyl.

Amongst poly(alkenylene(poly)cycloalkyl) adhesive polymers, especially pressure sensitive adhesive (‘PSA’) polymers, preferred polymers are copolymers in which the comonomer is an inertly substituted polycycloalkene monomer in which the substituents are chosen for their ability to promote tack (‘PSA functional groups’).

Examples include carboxylic ester groups, in particular branched C₁₋₁₂ alkyl esters, such as 2-ethylhex-1-yloxycarbonyl.

Preferred monomers of this type thus include polycycloalkenyl-mono- and bis-C₁₋₆ alkanoic C₆₋₁₂ branched chain alkyl esters, such as 5-(2′-ethylhex-1-yloxycarbonyl)- and 5,6-bis(2′-ethylhex-1-yloxycarbonyl)-norbornene; and mixtures thereof; in which the 5- and 6-substituents may each independently be in the exo- or endo-orientation.

Especially preferred PSA-functional monomers are those containing at least two PSA-functional groups present in the monomer.

Particularly preferred polymers include copolymers of any of
5-acryloxy-, 5-methacryloxy-, 5,6-diacryloxy- and 5,6-di(meth-acryloxy)-norbornene; and
5-(2′-acryloxyethoxycarbonyl)-, 5-(2′-methacryloxyethoxycarbonyl)-, 5,6-bis(2′-acryloxyethoxycarbonyl)-, and 5,6-bis(2′-methacryloxy-ethoxycarbonyl)-norbomene; and mixtures thereof;
   with either of
5-(2′-ethylhex-1-yloxycarbonyl)- and 5,6-bis(2′-ethylhex-1-yloxy-carbonyl)-norbornene; and mixtures thereof;
   in all of which monomers the 5- and 6-substituents may each independently be in the exo- or endo-orientation.

Examples of such include those in which comprise up to 50% by weight of the polymer, preferably up to 40% by weight and more preferably up to 20% by weight, of monomer species that contain one or two curable moieties.

In functionally substituted norbornene and structurally related monomers, the properties of the monomer, and hence polymer will also depend on the orientation of any functional substituents, whether curable moiety substituents or for example tack- or cohesion-improving substituents. They may in norbornene for example be endo-, exo-, bis(endo-), bis(exo-), and endo- exo- in the 5- and 6- positions, optionally with two orientations in the 7-position. For a tacky but cohesive PSA, for example, 5-exo and 6-exo substituents are preferred.

Suitable polyurethanes for use as the switchable polymer in the curable composition can be derived from
a) a polyfunctional isocyanate reactive compound, such as a polyester, preferably polyether, diol, aminol and/or diamine and a polyisocyanate, such as a di-isocyanate,
b) together with a polyfunctional isocyanate reactive compound, such as a polyester, or preferably polyether, diol, aminol and/or diamine, and/or a polyisocyanate, such as a di-isocyanate that comprises at least one reactive group that is curable but unreactive under conditions under which the hydroxy or isocyanate groups (as appropriate) undergo reaction.

For example a polyurethane polymer that contains unreacted curable acryloxy or methacryloxy groups may be formed by a urethane polymerisation reaction between
a) an acryloxy- or methacryloxy- diol, and
b) a diisocyanate, or less usually between
i) an acryloxy- or methacryloxy-diisocyanate, and
ii) a diol.

Suitable polyether diols include polyoxyalkylenediols in which the alkylene contains 2 to 4 carbon atoms such as polyoxyethylene, polyoxypropylene and polyoxytetramethylene diols and mixtures thereof.

Such polyether diols can suitably have an average molecular weight of 1000 to 8000 and preferably have a molecular weight of 1500 to 6000. A favoured polyether diol for forming the used in the invention is polyoxypropylene diol. An apt diol of this type is known as PPG 2025, available from British Drug House, which has an average molecular weight of 2025.

Another suitable diol, which contains hydrophilic groups, is a block copolymer of polypropylene glycol and ethylene oxide marketed as Dowfax 63N10 (Trade Mark) available from Dow Chemicals Inc.

Polyoxymethacryloxy-diol residues can be used to render the curable formed therefrom moisture vapour transmitting.

Suitable polyether diols that comprise at least one reactive group that is curable but unreactive under conditions under which the hydroxy groups undergo reaction with isocyanate groups include polyoxyalkylene/(meth)acryloxyalkylene copolymer diols. In these, the alkylene groups each independently contain 2 to 4 carbon atoms and no carbon atom bears two oxy groups.

Examples include copolymers or polyoxyethylene, polyoxypropylene and polyoxytetramethylene diols and mixtures thereof with (meth)acryloxy-propylene and -tetramethylene diols and mixtures thereof.

The (meth)acryloxy-diols may be prepared by esterifying the corresponding triols.

Diisocyanates used to form the polyurethane may suitably have an isocyanate functionality of 1.6 to 2.05. They preferably have an isocyanate functionality of about 2.0.

Suitable diisocyanates include an aliphatic (including alicyclic) and aromatic diisocyanates.

Favoured diisocyanates include toluene diisocyanate, 4,4′-diphenylmethane diisocyanate and 4,4′-dicyclo hexyl methyl diisocyanate. The latter is the preferred diisocyanate, which in an apt form is known as Desmodur W (Trade Mark) available from Bayer.

The polyurethane can optionally include a chain extending agent. Suitable chain extending agents include diols such as ethane diol and butane diol, dialkenes for example ethylene dialkene, and water.

The molar ratio of diol or diol and dialkene residues to diisocyanate residues in the polyurethane can suitably be 0.6 to 0.8:1 and preferably 0.65 to 0.75:1 for example 0.7:1.

The remainder of the free isocyanate groups may react with, for example, hydroxyl groups containing groups, which are present as chain terminators.

The amount of the curable but unreactive monomer residue present in the switchable curable composition may vary. This will depend, inter alia, upon the amount of tackiness desired in the switchable curable when it switches from its tacky to its less or non-tacky state.

Thus, the amount of the monomer residue.present in the switchable curable composition may be up to 15% by weight of polymer, preferably up to 10% by weight and more preferably up to 7% by eight.

Mono-ols that are tackifying agents can be used to react with free socyanate groups of the polyurethane.

Such mono-alcohols include hydrogenated mono hydroxy tackifying resins, for example hydrogenated abietyl alcohol.

A hydrophilic polyurethane can be formed by suitable choice of polyether diol.

Such a polyurethane may be hydrated, and when hydrated may contain from 35 to 95% by weight of water, aptly 50 to 92%, preferably 70 to 90% and more preferably 75 to 85% by weight. The degree of water absorption can be determined by taking a known weight of the polyurethane and immersing in water for 24 hours.

The hydrated polymer is removed from the water, excess water is removed by lightly blotting with absorbent paper and then the hydrated polyurethane is weighed.

The water absorption of the polyurethane (percentage by weight) can then be calculated as (weight of hydrated polyurethane-weight of dry polyurethane) ×100/weight of hydrated polyurethane.

When the polymer comprises a polyurethane curable it may be a lightly cross-linked or linear polyurethane curable.

The switchable curable compositions of the invention will often be include or be used in conjunction with at least one of which comprises free radical initiator that reacts to electromagnetic radiation. Any conventionally known free radical photoinitiators may be used.

Particularly preferred are those which react to visible light radiation, although initiators that react under longer or shorter wavelength light may be used in compositions of the invention.

Thus, free radical initiators that may be mentioned include titanocene photoinitiators; dye-and-co-initiator systems, for example thionine and triethanolalkene; and dye-and-borate salt systems.

Others that may be mentioned include dye-and-peroxide systems and 1,2-diketone/co-initiator systems, for example camphorquinone and tertiary alkene.

Preferred free radical initiators include titanocene initiators such as bis(hapto⁵-cyclopentadienyl) bis [2,6-difluoro-3-(IH-pyrr-I-yl) phenyl]-titanium, sold as Irgacure 784 (Trade Mark) in the UK by Ciba Geigy.

Initiators that react with UV light may be used, such initiators include the Irgacures, such as Irgacure 651 (benzyl dimethyl ketal) or Irgacure 907 (2-methyl-1-[4-(methylthio)phenyl]-2-morpholino-propan-1-one); or the Uvatones, such as Uvatone 8302 (2,2-diethoxy-1,2-diphenyl ethanone).

The switchable curable compositions of the invention are preferably provided with a photoinitiator.

According to a third aspect of the invention we provide a process for the manufacture of a curable composition as hereinbefore described characterised by admixing a switchable curable polymer of the present invention with other conventional components of curable compositions, and optionally with at least one other curable material.

According to one embodiment of this third aspect of the invention we provide a process for the manufacture of an adhesive composition as hereinbefore described characterised by admixing with other conventional components of curable compositions, a switchable polymer -as hereinbefore described which is adhesive, or a switchable polymer as hereinbefore described which is non-adhesive together with a non-switchable adhesive.

In a fourth aspect of the invention we provide a process for manufacturing a switchable polymer of the invention, characterised by reacting a monomer precursor of a residue in the backbone of the polymer, which monomer comprises at least two reactive groups, one of which is curable but unreactive under conditions under which at least one of the remaining groups undergoes reaction to form the polymer.

Bonding of the monomers to form a residue in the backbone is preferably effected via a ring opening metathesis polymerisation of a polycyloalkene and/or via an isocyanate—isocyanate reactive group addition. Such reactions may be carried out under the appropriate conventional reaction conditions.

In particular in one embodiment of this feature, we provide a process for the manufacture of an poly([meth]acryloxy-substituted ethenylenecyclopentyl) switchable curable, and in particular adhesive, polymer as hereinbefore described, characterised by reacting
a) a norbornenyl (meth)acrylate monomer precursor of the meth]acryloxy-substituted ethenylenecyclopentyl residue in the polymer,
b) optionally with a norbornene with at least one other substituent, each of which are inert.

We also provide a process for the manufacture of a polyurethane switchable polymer as hereinbefore described, characterised by reacting a polyisocyanate with at least one compound that comprises
a) at least two isocyanate-reactive groups and
b) at least one reactive group that is curable but unreactive under conditions under which the isocyanate and isocyanate-reactive groups undergo reaction.

Monomers for the present polymers may be prepared by derivatising a corresponding intermediate
a) without a curable but unreacted group, but
b) which is derivatisable thereto, with a derivatising precursor of the group.

These precursors of the monomers may for example contain hydroxyl groups, which may be esterified with curable acid derivatives.

For example norbornenyl acrylate or methacrylate may be prepared respectively by conventional acrylation or methacrylation of norborneol with acryloyl or methacryloyl chloride.

Similarly, a diol monomer possessing at least one acryloyl or methacryloyl group may be prepared respectively by conventional acrylation or methacrylation of the relevant polyol with acryloyl or methacryloyl chloride.

The precursors may contain reactive primary amine groups, which may be similarly derivatised to give a monomer with groups that are curable but unreactive under conditions under which each of the remaining groups undergoes polymerisation reaction.

As noted above, preferred monomer residues include photocurable moieties.

Preferred curable moieties also include those which change the curable composition from one state to another as hereinbefore described by producing a polymer of increased molecular weight by way of free-radical linking or cross-linking the switchable polymer.

Such curing may be initiated by visible light or longer or shorter wavelength light such as infra red or ultra violet light.

Whilst it is preferable that the curable residue reacts via irradiation, it is most desirable that the reaction of the curable groups is visible light initiated. Thus the wavelength of the light used may be less than 700 nm, for example preferably between 400 and 700 nm.

The dosage of light used may vary depending upon the switchable curable composition but is generally greater than 0.4 mW cm⁻² when UV light is used.

When a visible light switchable curable composition is used, ambient light may be used and therefore the dosage may vary.

As noted above, the switchable curable compositions of the invention may also be blended with a conventional curable composition to produce a curable mixture that is switchable.

The curable compositions of the invention are particularly advantageous in the manufacture of curable tapes, bandages, dressings, and prostheses. In the term ‘dressings’ we include wound dressings. In the term ‘bandages’ we include those for medical use and those for orthopaedic, for example splinting or casting, use.

The curable compositions may also be useful in the manufacture of other conventional products that require a curable composition.

Thus according to the invention we provide the use of a composition as hereinbefore described in the manufacture of a curable article.

Preferred curable compositions of the invention include pressure sensitive curable compositions (PSAs) and are particularly advantageous in the manufacture of adhesive tapes, bandages and dressings. By the term ‘dressings’ we include wound dressings.

The curable compositions may also be useful in the manufacture of other conventional products that require a peelable adhesive, for example, masking tapes, stencils, etc.

Thus according to the invention we provide the use of a composition as hereinbefore described in the manufacture of an adhesive dressing, bandage or tape.

Preferred curable compositions of the invention include orthopaedic bandage and prosthetic hardenable compositions, and are particularly advantageous in the manufacture of hardenable tapes and hardenable bandages. By the term ‘bandages’ we include hardenable orthopaedic splint bandages and other hardenable tapes for orthopaedic use.

The hardenable compositions may also be useful in the manufacture of other conventional products that require a hardenable material.

Thus according to the invention we provide the use of a composition as hereinbefore described in the manufacture of a hardenable bandage or tape.

Products comprising curable compositions of the invention are also themselves novel.

Thus according to a further feature of the invention we provide a curable product comprising a curable composition as hereinbefore described.

Tapes, bandages and dressings comprising curable compositions of the invention are also themselves novel.

Thus according to a further aspect of the invention we provide a curable product comprising a backing layer characterised in that the backing layer is substantially coated on at least one surface thereof with a curable composition as hereinbefore described.

In one embodiment of this aspect of the present invention, we provide an adhesive dressing comprising a backing layer characterised in that the backing layer is substantially coated on at least one surface thereof with an adhesive composition as hereinbefore described.

Suitably the backing layer may have a thickness of from 0.375 mm to 1.25 mm, more suitably will be 0.45 mm to 1.0 mm thick and preferably 0.50 mm to 0.875 mm thick, for example 0.825 mm.

In another embodiment of this feature of the present invention, we provide an hardenable tape or bandage comprising a backing layer characterised in that the backing layer is substantially coated on at least one surface thereof and/or impregnated or encapsulated with a hardenable composition as hereinbefore described.

Suitably the backing layer may have a thickness of from 0.375 mm to 1.25 mm, more suitably will be 0.45 mm to 1.0 mm thick and preferably 0.50 mm to 0.875 mm thick, for example 0.825 mm.

It will be appreciated that the switchable curable composition of the present invention will tend to begin to change from a one state to another once its curing reaction has been initiated by any radiation to which it is susceptible. Thus, for storage stability the curable product should be in a form that prevents initiation of the curing reaction.

Accordingly, where exposure to the relevant radiation is sufficient to initiate the reaction, with or without a photooinitiator in the curable composition, the curable composition in the curable product should be shielded from the radiation by means of sufficient occlusive materials. (By ‘occlusive’ we mean that the material is occlusive over the wavelength range in which the curable composition is switchable and/or in which the photoinitiator absorbs.)

Particularly preferred curable compositions of the present invention are those which react to visible light radiation.

Accordingly, it is particularly preferred that any occlusive components are occlusive to visible light radiation.

Thus, for example, the product may be stored in an occlusive pouch. When it is a tape, dressing or bandage, it may be provided with an occlusive backing layer or cover layer if for example as a roll, and with one or more occlusive release liners on the curable composition if not.

All such products, but in particular those which are visible light sensitive, should be adapted to permit the curable composition to be irradiated as and when appropriate, for example
a) to permit ready removal of an adhesive product from any substrate to which it has been applied, or
b) to permit ready hardening of a hardenable product on any substrate to which it has been applied.

In the case of an adhesive product comprising a backing layer, in order to facilitate its removal from any substrate to which it has been applied, the backing layer preferably comprises
a) a removable occlusive layer overlying
b) a transmissive, that is, transparent or translucent, layer that bears the adhesive composition on a face away from the occlusive layer.

We especially prefer an occlusive layer that is visible light occlusive, and a transmissive layer that is visible light transmissive.

It is preferred that the occlusive layer is continuous; however, the transmissive layer may be a continuous layer, or any variety of discontinuous layer.

The latter includes perforated layers, and integral net layers where the area of the voids in the net exceeds the area of the material of the layer.

It also includes all structures intermediate in structure between those mentioned here.

The adhesive coating may be a continuous coating or non-continuous coating, for example may be a pattern spread adhesive on a continuous surface of the backing layer.

Where the backing layer comprises a transmissive layer, the adhesive will form a coating on the transmissive layer, which of which coating may again be continuous or non-continuous.

The occlusive layer should of course fully overlie the adhesive composition.

The occlusive and transmissive layers may be reversibly bonded together in any manner.

For example, the occlusive layer may be adhesively bonded to the Tran missive layer. If adhesively bonded, then the peel strength of the bonding adhesive must be less than that of the switchable adhesive composition in its tacky form.

In use, an adhesive product, in particular a dressing, of the invention may be applied to the skin of a patient.

When it is desired to remove or replace the product, the occlusive layer may be removed. The adhesive on the substrate-facing, in particular skin-facing, surface of the transmissive layer can then be exposed to a source of appropriate electromagnetic radiation, preferably visible.

After a given time the peel strength of the adhesive will be reduced allowing the transparent layer to be removed from the substrate, in particular the patient's skin.

Thus according to the invention we provide an adhesive product, in particular a dressing, as hereinbefore described comprising a backing layer and an adhesive layer, characterised in that
a) the backing layer comprises a removable occlusive layer and a transmissive layer between the occlusive layer and the adhesive layer and
b) the adhesive layer comprises a switchable adhesive composition as hereinbefore described.

Any conventionally known occlusive and transmissive materials may be used in the backing layer of the adhesive product, in particular the dressings, of the invention. Preferred adhesive products, in particular dressings are those which of which comprise a film, for example a thin film, backing layer, that is, both the occlusive and transmissive layers comprise or are a film.

However, other backing layers, for example fabric layers, may also be considered appropriate.

The adhesive products, in particular the dressings, of the invention may be manufactured using conventional methods known per se.

According to a further feature of the invention we provide a method of use of the adhesive product of the present invention. It is characterised by adhesively contacting a part of the adhesive product bearing an adhesive composition of the invention to a substrate.

The method may also include the removal of such a product that comprises an occlusive layer and a transmissive layer by
a) removing the occlusive layer from the product and then
b) irradiating the adhesive composition through the transmissive layer to render the adhesive composition less tacky.

The dressings of the invention are especially useful in the treatment of wounds.

Thus according to a further feature of the invention we provide a method of treating a wound on a patient, characterised by adhesively applying a dressing of the invention to the wound.

The method may also include the removal of such a dressing which of which comprises an occlusive layer and a transmissive layer by
a) removing the occlusive layer from the product and then
b) Irradiating the adhesive composition through the transmissive layer to make the adhesive composition less tacky.

The curable products of the present invention also comprise hardenable tapes and bandages, in particular an orthopaedic splinting bandage. These comprise a backing layer substantially coated on at least one surface thereof and/or impregnated or encapsulated with a hardenable composition as hereinbefore described.

In order to facilitate its transfer to any substrate to which it is to be applied, the bandage preferably comprises a removable occlusive layer overlying the backing layer. Where at least one face of the bandage bears the hardenable composition, it will generally be on a face towards,the occlusive layer. We especially prefer an occlusive layer that is visible light occlusive.

It is preferred that the occlusive layer is continuous.

The hardenable composition may be present at least in part as a continuous coating or non-continuous coating, for example, it may be a pattern spread on a continuous surface of the bandage.

Where the bandage comprises a backing layer impregnated or encapsulated by the composition, the impregnation or encapsulation may again be continuous or non-continuous.

The occlusive layer should of course fully overlie the hardenable composition.

The occlusive layer and the backing layer or the relevant face of the bandage may be reversibly bonded together in any manner.

For example, the occlusive layer may be adhesively bonded to the backing layer or face.

In use, a hardenable product, in particular an orthopaedic splint bandage, of the invention is applied generally around a bone fracture in a patient. Often once it has been applied, the occlusive layer may be removed. The hardenable composition on and/or in the backing layer can then be exposed to a source of appropriate electromagnetic radiation, preferably visible.

After a given time the flexural strength of the hardenable composition will be increased allowing the bandage to stay in situ and support the substrate, in particular the patient's fracture.

Thus according to the invention we provide an hardenable orthopaedic product, in particular an orthopaedic splint bandage, as hereinbefore described, comprising a bandage comprising a hardenable composition of the invention. It is characterised in that the product comprises a removable occlusive layer on at least one face of the bandage.

Any conventionally known occlusive materials may be used in the hardenable products, in particular the orthopaedic splint bandages, of the invention.

Preferred hardenable products, in particular orthopaedic splint bandages are those which comprise a film, for example a thin film, occlusive layer. However, other backing layers, for example fabric layers, may also be considered appropriate.

Any conventionally known materials may be used in the backing layer of the hardenable products, in particular the orthopaedic splint bandages, of the invention.

Preferred hardenable products, in particular orthopaedic splint bandages are those which comprise a fabric, for example a thin fabric, backing layer. However, other backing layers, for example film layers, may also be considered appropriate.

The orthopaedic splinting bandages of the present invention may desirably possess lengthways elastic extensibility by virtue of the presence in the backing layer of elastic fibres. As used herein, the term “fibre” relates to the yarn material that used whether that yarn is composed of mono or multifilaments.

The extension at a given load and the load required to give a given extension can be calculated from the curve for the backing layer under test.

Thus, for example, the backing layer may be or comprise a woven or knitted fabric of inelastic fibres and elastic fibres, said elastic fibres being incorporated in the backing layer in the length direction.

The inelastic fibres may have a low modulus of elasticity, for example, a fibre in which individual filaments have a modulus of less than 1.38×10⁸ Pa.

The elastic fibres may be low modulus fibre, that is, a fibre in which individual filaments have a modulus of less than 2.07×10¹⁰ Pa (3×10⁶ psi), more suitably less than 1.38×10¹⁰ (2×10⁶ psi) and preferably less than 6.90×10⁹ Pa (10⁶ psi).

In another aspect the present invention provides a conformable visible light hardenable orthopaedic splinting bandage comprising a knitted backing layer coated and/or impregnated or encapsulated with a hardenable composition of the present invention. The backing layer comprises inelastic fibres and elastic fibres, said elastic fibres being incorporated in the backing layer in the length direction. It is characterised in that the inelastic fibres have a low modulus of elasticity, that is, a fibre in which individual filaments have a modulus of less than 1.39×10⁸ Pa.

The remainder of the knitted backing layer may be or include polymer fibres such as polypropylene, polyester, polyamide and polyethylene. The low modulus fibre may have a modulus of elasticity of less than 6.90×10⁷ Pa (10⁴ psi). A preferred fibre is formed from polypropylene and may be employed as a multifilament or monofilament fibre. A second preferred fibre is polyester including multifilament or monofilament polyethylene terephthalate fibre.

The use of such yarns leads to particularly durable casts.

The hardenable products, in particular the bandages, of the invention may be manufactured using conventional methods known per se.

According to a further feature of the invention we provide a method of use of the hardenable product of the present invention, characterised by contacting a hardenable product comprising a hardenable composition of the invention to a substrate.

The dressings of the invention are especially useful in the treatment of bone fractures.

Thus according to a further feature of the invention we provide a method of treating a bone fracture in a patient, characterised by applying a bandage of the invention around the bone fracture.

The method may also include the application of such a product that comprises an occlusive layer and by
a) removing the occlusive layer from the product and then
b) irradiating the hardenable composition in the bandage to render it solid or less flexible.

The bandage systems of the invention are especially useful in the treatment of bone fractures.

Many medicinal agents are suitable for incorporation into the curable compositions of the present invention.

By medicinal agent is meant pharmacologically active agents including agents that are topical anaesthetics such as xylocaine, bacteriostatic agents such as silver nitrate; anti-bacterial agents of which preferred forms are silver sulphadiazine and chlorhexidine salts; and antibiotics; topical steroids, enzymes; tissue stimulants; coagulants and anticoagulants and antifungal agents.

Other agents such as emollients may also be added.

The invention will now be illustrated with reference to the accompanying drawings and Examples, in which drawings:

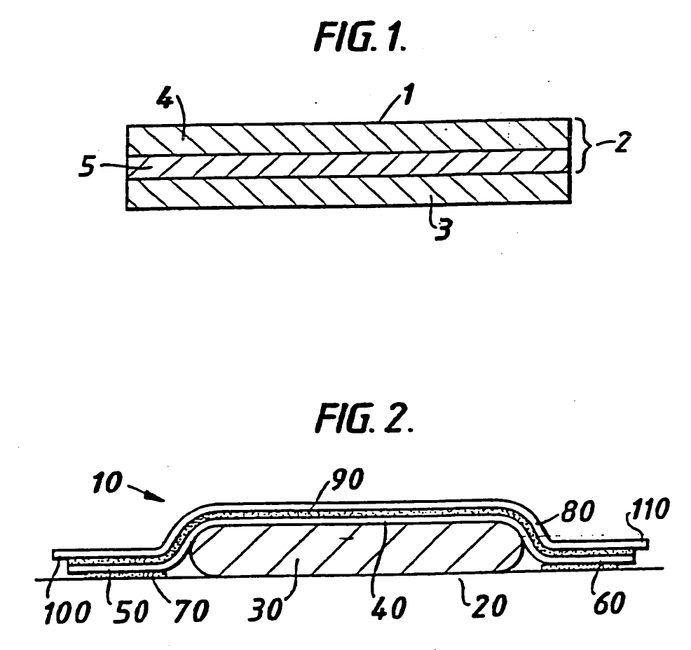

FIG. 1 is a cross-section of a dressing of the invention.

FIG. 2 is a cross-section of a further dressing embodiment of the invention when in use on a patient.

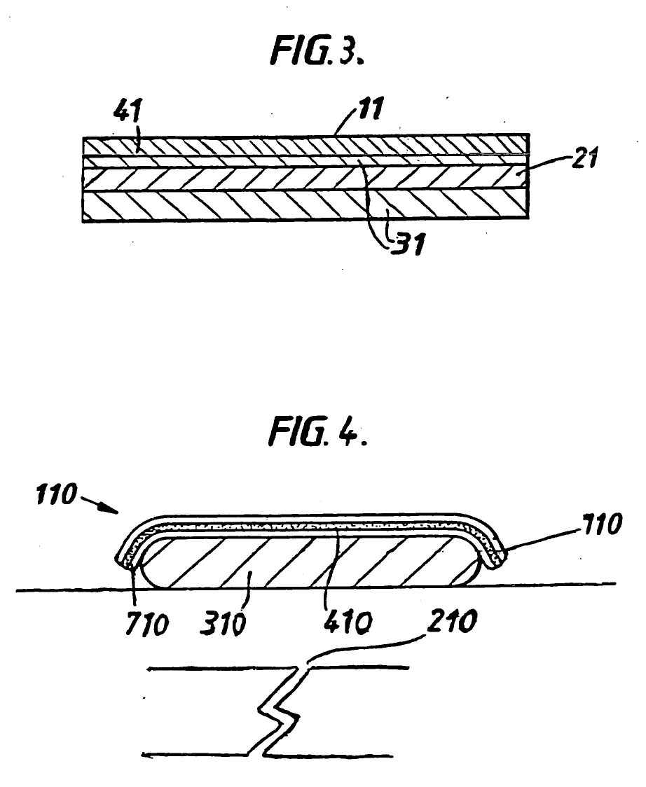

FIG. 3 is a cross-section of a bandage of the invention.

FIG. 4 is a cross-section of a further bandage embodiment of the invention when in use on a patient.

With reference to FIG. 1, a dressing (1) comprises a backing layer (2) and an adhesive layer (3) of a switchable pressure-sensitive adhesive (PSA) of the present invention that has pendant acryloxy groups.

The backing layer (2) comprises an occlusive layer (4) and a transmissive layer (5) between the occlusive layer (4) and the adhesive layer (3). The dressing may optionally be provided with appropriate carrier layers and protector layers.

In use the dressing (1) is adhered to the skin of a patient when the adhesive layer (3) is in a tacky form.

When it is desired to remove the dressing (1) from the patient, the occlusive layer (4) is removed exposing the transparent layer (5) and thereby the adhesive layer (3) to visible light.

The visible light causes the photoinitiator to initiate free-radical cross-linking of the PSA through the pendant acryloxy groups resulting in the adhesive losing its tackiness.

The time required for this reaction to be complete may vary, for example, from 1 to 15 minutes. The dressing may then be removed with reduced trauma to the patient.

Referring now to FIG. 2, a medical dressing (10) is shown attached to a patient's skin (20).

The dressing (10) comprises a wound facing absorbent layer (30) which is underneath a protective backing layer (40).

At opposed edges (50, 60) the backing layer (40) is provided with adhesive layer (70) that comprises a switchable polymer having groups that can be cross-linked under the influence of UV or visible light.

The backing layer (40) is provided with a cover (80) which is releasably secured to the backing layer (40) by a weak adhesive (90). Alternatively the cover (80) may be laminated to the backing layer (40). For ease of removal the cover (80) overlaps the backing layer (40) at its edges (100, 110).

When it is desired to remove the dressing from the skin of a patient, the cover (80) can be gripped at its edges (100, 110) and peeled off the backing layer (40).

This exposes the adhesive layer (70) to UV or visible light irradiation.

This irradiation acts so as to cure the switchable polymer in the adhesive layer.

This, after a certain time (depending upon the adhesive used), causes the adhesive layer (70) to lose its tackiness to such an extent that the dressing can be removed without causing trauma to the patient.

The removal of the cover (80) should not itself cause removal of the dressing before switching.

Accordingly, the peel strength of the adhesive (90) adhering the cover (80) to the backing layer (40) should be substantially less than that of the adhesive layer (70) adhering the dressing (10) to the patient's skin.

The adhesive (70) loses tackiness on exposure to UV or visible light.

It is therefore desirable that the adhesive layer (70) is not exposed to the light for a substantial period when the dressing (10) is applied to a patient. Thus the adhesive layer (70) may be initially provided on the surface with release paper (not shown) which is opaque to UV and visible light and which can be readily removed from the adhesive so that the dressing is ready for use.

With reference to FIG. 3, a bandage (11) comprises a backing layer (21) impregnated with, and coated with layers (31) of, a switchable hardenable composition of the present invention that has pendant acryloxy groups.

The bandage (21) bears an occlusive layer (41) on one layer (31). The bandage may optionally be provided with appropriate protector layers.

In use the bandage (11) is applied around a fracture in a patient when the hardenable composition (including layers (31)) is in a flexible form, and the occlusive layer (41) is removed exposing the hardenable composition to visible light.

The visible light causes the photoinitiator to initiate the free-radical cross-linking of the hardenable composition through the pendant acryloxy groups resulting in the hardenable composition increasing its flexural strength.

The time required for this reaction to be complete may vary, for example, from 1 to 15 minutes. The bandage may then be left in situ to support the fracture in the patient.

Referring now to FIG. 4, a medical bandage (110) is shown around a patient's fracture (210).

The bandage (110) has been applied to the patient over a conventional protective underbandage (310), and comprises a backing layer (410) impregnated with, and coated with layers (710) of, a switched hardenable composition of the present invention that had pendent acryloxy groups that have been cross-linked under the influence of UV or visible light.

The preparation and testing of adhesive compositions suitable for use as the adhesive layers in switchable adhesive dressings will now be described in the following Examples:

D.1 Synthesis of Monofunctional Monomers:

A mixture of exo- and endo-norborn-2-en-5-ylmethanol (I) (5.53 g) was dissolved in chloroform (ca 30 ml); acryloyl chloride (3.9 g) (II) was added.

The mixture was heated to reflux and then held at 50° C. for 15 hr.

The chloroform was then evaporated off to leave a pale yellow liquid, identified by n.m.r as of structure (M.1), a mixture of exo- and endo-norborn-2-en-5-ylmethyl acrylate.

D.2 Synthesis of Difunctional Monomers:

Endo,exo-5,6-bis(chlorocarbonyl)norborn-2-ene (III) (6.06 g 0.0276 mol) and 2-hydroxy-ethyl methacrylate (IV) (HEMA) (7.2 g 0.0554 mol) were mixed in a 100 ml round bottomed flask.

The mixture was stirred. After 1-2 min. an exothermic reaction began, and gas was evolved (hydrogen chloride). The mixture was heated in an oil bath at 50° C. and stirred for ca 90 mins.

The ¹H/¹³C n.m.r. spectrum of a sample evaporated in vacuo (30 min.) indicated reaction to form endo,exo-5,6-bis(2-methacryloxyethoxycarbonyl)norborn-2-ene (M.2).

D.3 Synthesis of Non-Functional Monomers:

2-Ethylhexanol (33.0 g) and exo-norborn-2-en-5,6-dicarboxylic anhydride (20.8 g) were heated for 1.5 hrs in toluene (to 30% solids).

Concentrated sulphuric acid (1 ml) was added. The reaction mixture was refluxed for a further 48 hr.

The product exo,exo-5,6-bis(2-ethylhexyloxycarbonyl)norborn-2-ene (M.3) was isolated from the reaction mixture by rotary evaporation of solvent in vacuo. The product was confirmed as pure by ¹H and ¹³C n.m.r.

E.1 Copolymerisation of Monofunctional and Non-Functional monomer: (M.3) (4.5 g) and (M.1) (0.5 g) were mixed in chloroform at 40% w/w solids.

The monomers were degassed with argon for 5 mins before adding the initiator, Grubbs catalyst (bis(tricyclohexylphosphine)-benzylidene-ruthenium(IV) dichloride) (25mg). The mixture was stirred at 20° C. for 15 hr.

The ¹H n.m.r. (CDCl₃ ) of a syrup-like evaporated sample indicated the presence of acrylate groups and that polymerisation has occurred.

E.2 Copolymerisation of Difunctional and Non-Functional Monomer:

(M.2) (0.55 g) from D.2 above and (M.3) (4.45 g) from D.3 above were polymerised under conditions as in E.1.

The final viscosity was significantly higher than the initial. The ¹H n.m.r. shows that polymerisation has occurred, and that methacrylate groups are present.

F.1 Cross-Linking and Testing of Functionalised Polymers.

40% syrups of the polymers of E.1 and E.2 (ca 5 g) were each mixed separately with Irgacure 651 photoinitiator (ca 5% on wt. of polymer) to dissolve it.

Films of the products were prepared on silicone release paper and the solvent evaporated off.

The tacky films were covered with transparent Melinex sheet, and half was irradiated for 3 mins in a UV cabinet.

Results of Irradiation:

| SAMPLE | BEFORE | AFTER |
|---|---|---|
| E.1 | Tacky, low cohesion | No tack, higher cohesion |
| E.2 | Tacky, low cohesion | No tack, higher cohesion |

The results clearly demonstrate that the novel adhesive compositions of the invention perform well. Compared with the prior art, they can be made, far more controllably.

1. An adhesive dressing comprising a backing layer substantially coated on at least one surface thereof with an adhesive composition comprising a switchable polymer capable of being influenced by radiation to change from one state to another, comprising a backbone polymeric moiety having a plurality of curable residues bonded thereto, wherein the polymer comprises monomer residues each of which monomers comprises at least two reactive groups, one of which is curable but unreactive under conditions under which at least one of the remaining groups undergoes a reaction to form the polymer.

2. A hardenable tape or bandage comprising a backing layer substantially coated on at least one surface thereof and/or impregnated or encapsulated with a hardenable composition comprising a switchable polymer capable of being influenced by radiation to change from one state to another, comprising a backbone polymeric moiety having a plurality of curable residues bonded thereto, wherein the polymer comprises monomer residues each of which monomers comprises at least two reactive groups, one of which is curable but unreactive under conditions under which at least one of the remaining groups undergoes a reaction to form the polymer.
